(19) United States
(12) Patent Application Publication
(10) Pub. No.: US 2011/0088815 A1
(43) Pub. Date: Apr. 21, 2011

(54) ROTARY TYPE FEEDING DEVICE FOR WOODWORKING MACHINE

(76) Inventor: Chin-Chi Lin, Houli Township (TW)

(21) Appl. No.: 12/581,757

(22) Filed: Oct. 19, 2009

(51) Int. Cl. B27B 25/02

(52) U.S. Cl. 144/247; 83/436.6

(57) ABSTRACT

A rotary type feeding device for a woodworking machine includes a support post unit including a base adapted to be mounted on a worktable, and a pivot shaft disposed uprightly on the base. A cantilever unit includes a cantilever rotatable about the pivot shaft and having a pivot end proximate to the pivot shaft, and a free end distal from the pivot shaft, and a return member. A feeding wheel unit includes a feeding wheel disposed pivotally on the free end of the cantilever. The feeding wheel has a diameter that is not smaller than 250 mm. The return member of the cantilever unit is adapted for biasing the feeding wheel of the feeding wheel unit to pivot toward a cutter.

### BACKGROUND OF THE INVENTION

1. Field of the Invention

This invention relates to a feeding device more particularly to a rotary type feeding device for a woodworking machine.

2. Description of the Related Art

Referring to FIGS. 1 and 2, a woodworking machine 1 disclosed in U.S. Pat. No. 7,051,864 by the applicant comprises a worktable 101, a cutter 103 mounted on the worktable 101, a fence device 102, and a feeding device 10. The fence device 102 and the feeding device 10 are disposed respectively on two opposite sides of the worktable 101. The feeding device 10 includes a base 11, a cantilever device 12, a driving unit 13, and a feeding wheel 14. The cantilever device 12 has a cantilever 121 with a free end on which the feeding wheel 14 is disposed pivotally, and a pneumatic cylinder 122 that permits the feeding wheel 14 to pivot toward and away from the cutter 103. The driving unit 13 has a motor 131 driving a worm gear assembly (not shown) that is disposed inside the cantilever 121 and that drives the feeding wheel 14 to rotate.

When a cutting operation is performed, the pneumatic cylinder 122 is first driven for pivoting the cantilever 121 away from the cutter 103, and a workpiece 2 is placed on the worktable 101. Afterwards, the cantilever 121 is driven to pivot toward the cutter 103, and the workpiece 2 is pushed toward the cutter 103 along the fence device 102. Once the workpiece 2 contacts the feeding wheel 14, the workpiece 2 is moved by the feeding wheel 14 due to frictional contact between the workpiece 2 and the feeding wheel 14 during rotation of the feeding wheel 14. Therefore, the workpiece 2 is cut by the cutter 103. However, the aforementioned feeding device 10 suffers from the following disadvantages. An air pressure source for driving the pneumatic cylinder 122 is required, and pivoting movement of the cantilever 121 away from and toward the cutter 103 lengthens the duration of the cutting operation. Furthermore, since the motor 131 is disposed at an end of the cantilever 121, the woodworking machine 1 occupies a large amount of space.

### SUMMARY OF THE INVENTION

Therefore, the object of the present invention is to provide a rotary type feeding device for a woodworking machine capable of alleviating the above drawbacks of the prior art.

Accordingly, a rotary type feeding device of the present invention is adapted for use with a woodworking machine. The woodworking machine includes a body, a worktable disposed on the body, and a cutter extending through the worktable. The rotary type feeding device comprises a support post unit including a base adapted to be mounted on the worktable, and a pivot shaft disposed uprightly on the base. A cantilever unit includes a cantilever rotatable about the pivot shaft and having a pivot end proximate to the pivot shaft, and a free end distal from the pivot shaft, and a return member. A feeding wheel unit includes a feeding wheel disposed pivotally on the free end of the cantilever. The feeding wheel has a diameter that is not smaller than 250 mm. The return member of the cantilever unit is adapted for biasing the feeding wheel of the feeding wheel unit to pivot toward the cutter.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional woodworking machine disclosed in U.S. Pat. No. 7,051,864;

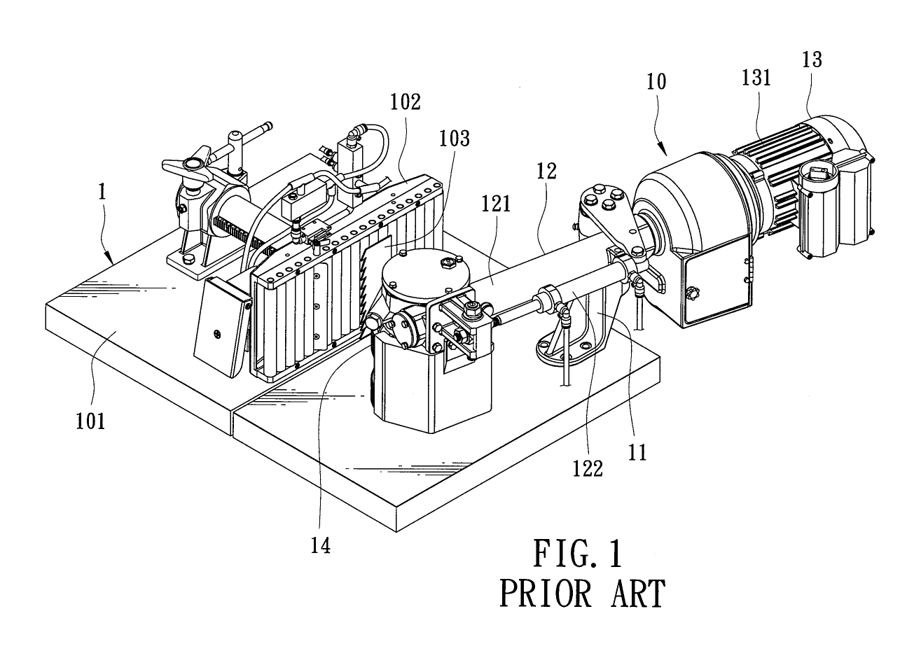

FIG. 2 is a schematic top view of the conventional woodworking machine;

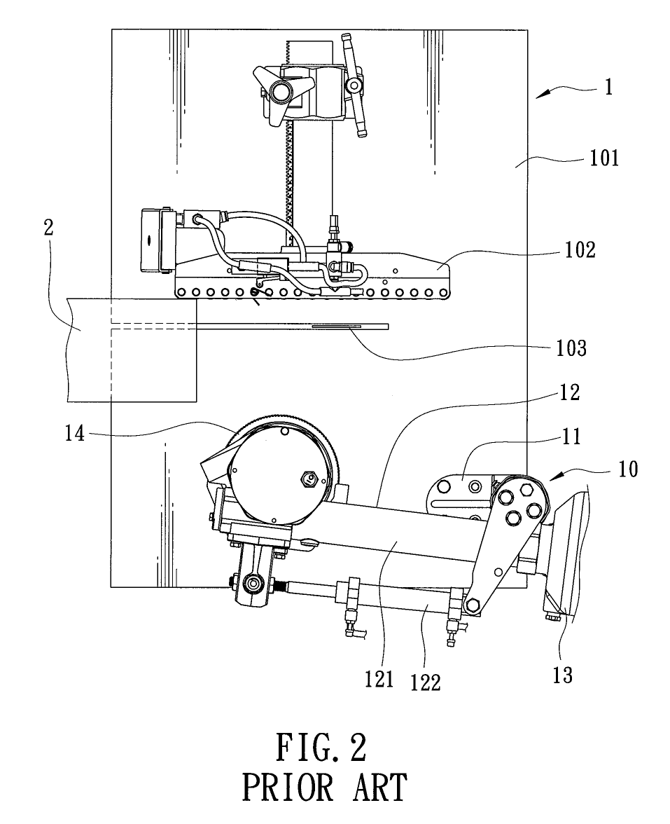

FIG. 3 is a perspective view of a preferred embodiment of a woodworking machine according to the present invention;

FIG. 4 is a fragmentary perspective view of the preferred embodiment, illustrating a supporting unit, a cantilever unit, a feeding wheel, and a driving unit;

FIG. 5 is a front view of the preferred embodiment;

FIG. 6 is a side view of the preferred embodiment;

FIG. 7 is a schematic top view of the preferred embodiment, illustrating a workpiece to be cut;

FIG. 8 is a fragmentary, partly sectional view of the preferred embodiment, illustrating a locking pin disposed on the cantilever unit;

FIG. 9 is a schematic top view illustrating the workpiece pushing the cantilever unit away from a fence member;

FIG. 10 is a schematic top view illustrating the cantilever unit located at an open position; and

FIG. 11 is a fragmentary sectional view of the preferred embodiment, illustrating the cantilever unit locked by the locking pin.

### DETAILED DESCRIPTION OF THE PREFERRED EMBODIMENT

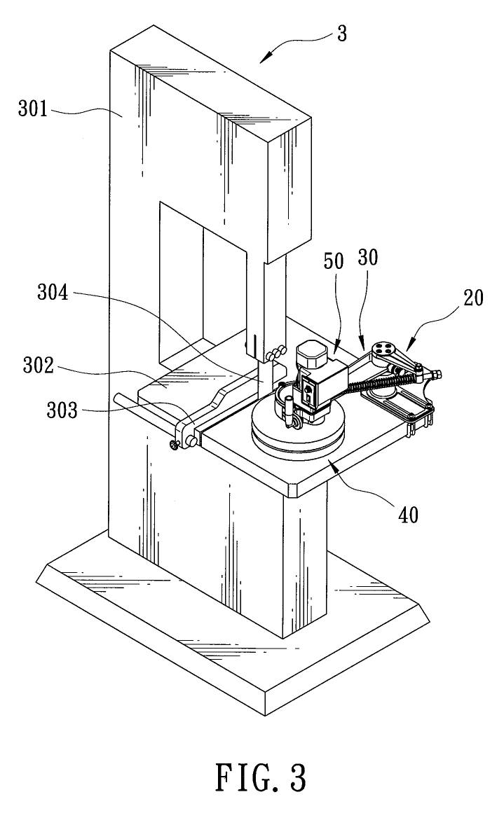

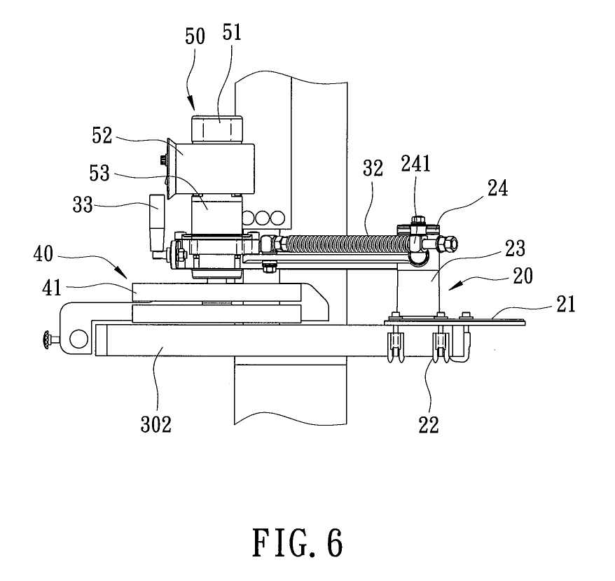

Referring to FIGS. 3 to 8, a preferred embodiment of a rotary type feeding device for a woodworking machine according to the present invention is shown. The woodworking machine 3 includes a body 301, a worktable 302 disposed on the body 301, a fence member 303, and a cutter 304 extending through the worktable 302. The rotary type feeding device comprises a support post unit 20, a cantilever unit 30, a feeding wheel unit 40, and a driving unit 50. In this preferred embodiment, the woodworking machine 3 is a band saw machine.

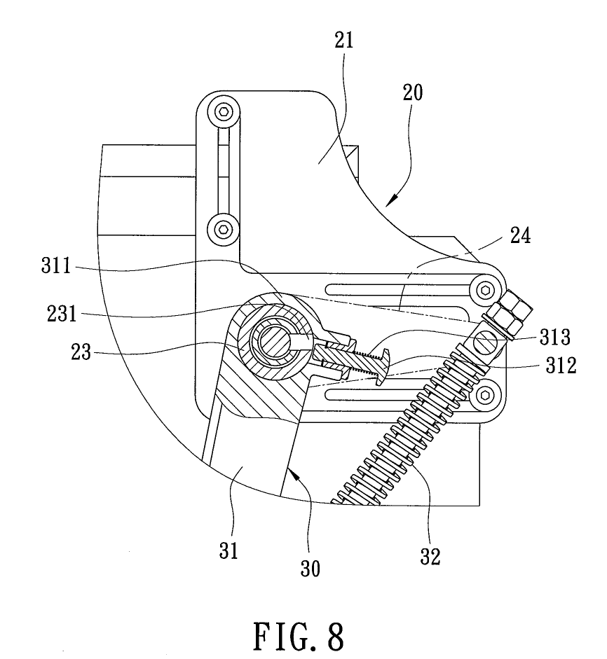

The support post unit 20 includes a base 21 adapted to be mounted on the worktable 302, a plurality of clamping members 22, a pivot shaft 23 disposed uprightly and fixedly on the base 21, and an extension rod 24 connected fixedly to and extending radially and outwardly from an upper end of the pivot shaft 23. The base 21 is formed with a plurality of slots 211 permitting the clamping members 22 to extend respectively therethrough. Each of the clamping members 22 includes a threaded rod 221 and a hook 222 engaging threadably the threaded rod 221 such that the worktable 302 is clamped between the base 21 and the hook 222. The pivot shaft 23 has an annular outer surface formed with a positioning hole 231 (see FIG. 8). The support post unit 20 further includes a rotating block 241 disposed rotatably on an end of the extension rod 24 distal from the pivot shaft 23.

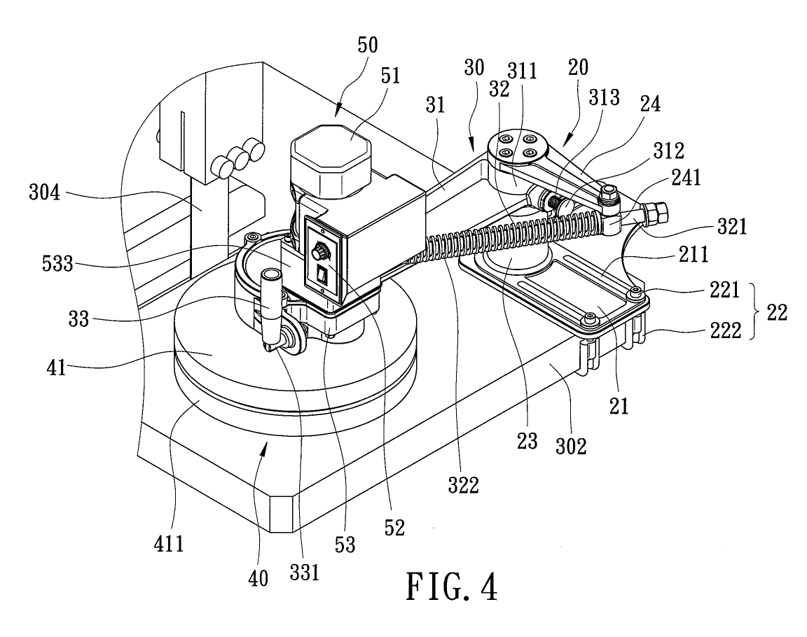

The cantilever unit 30 includes a cantilever 31 rotatable about the pivot shaft 23 and having a pivot end proximate to the pivot shaft 23, and a free end distal from the pivot shaft 23, a return member 32, and a rotary lever 33 having an end 331 connected pivotally to the free end of the cantilever 31 (see FIG. 4). The cantilever unit 30 further includes a sleeve ring 311, a locking pin 312, and a pin-biasing spring 313. The sleeve ring 311 is connected fixedly to the pivot end of the cantilever 31 and is sleeved rotatably on the pivot shaft 23. The locking pin 312 is disposed movably on the sleeve ring 311 and is movable to engage the positioning hole 231 in the pivot shaft 23 so as to prevent rotation of the cantilever 31 about the pivot shaft 23. The pin-biasing spring 313 is for biasing the locking pin 312 to remove from the positioning hole 231 in the pivot shaft 23.

The return member 32 includes a connecting rod 321 and a wheel-biasing spring 322. The connecting rod 321 has one end connected pivotally to the cantilever 31, and the other end extending movably through the rotating block 241. The wheel-biasing spring 322 is configured as a coiled compression spring, and is sleeved on the connecting rod 321 between the rotating block 241 and the cantilever 31.

The feeding wheel unit 40 includes a feeding wheel 41 disposed pivotally on the free end of the cantilever 31, and a friction layer 411 disposed on an outer surface of the feeding wheel 41. The diameter of the feeding wheel 41 is not smaller than 250 mm. In order to meet demand for available woodworking machines, the feeding wheel 41 has a diameter that is not greater than 990 mm. The wheel-biasing spring 322 is adapted for providing a biasing force to pivot the feeding wheel 41 toward the cutter 304. A ratio of the diameter of the feeding wheel 41 to a distance between the free end of the cantilever 31 and a central axis of the pivot shaft 23 is greater than 0.6, and smaller than 2.0.

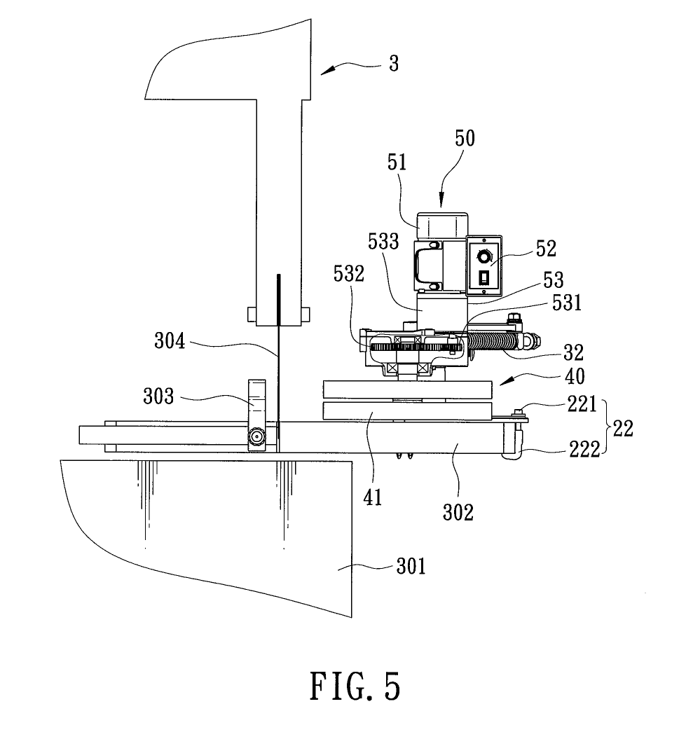

The driving unit 50 includes a motor 51, a switch 52 disposed on the motor 51, and a speed-reducing system 53 (see FIG. 5) disposed between the motor 51 and the feeding wheel 41. The motor 51 is disposed above the cantilever 31 and directly above the feeding wheel unit 40. The speed-reducing system 53 includes a small gear 531 driven by the motor 51, and a large gear 532 connected to the feeding wheel 41, meshing with the small gear 531, and having a diameter greater than that of the small gear 531. When the switch 52 is turned on, the feeding wheel 41 is driven to rotate at a speed smaller than that of an output shaft (not shown) of the motor 51. Preferably, the speed-reducing system 53 further includes a reduction box unit 533 connected between the motor 51 and the small gear 531 and including a speed-reducing mechanism such as a planetary gear set.

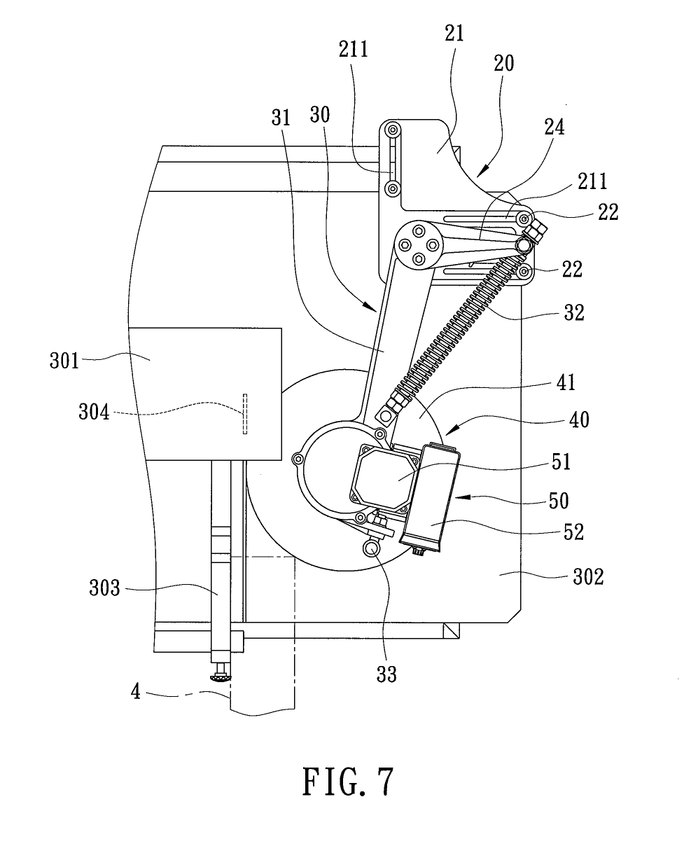

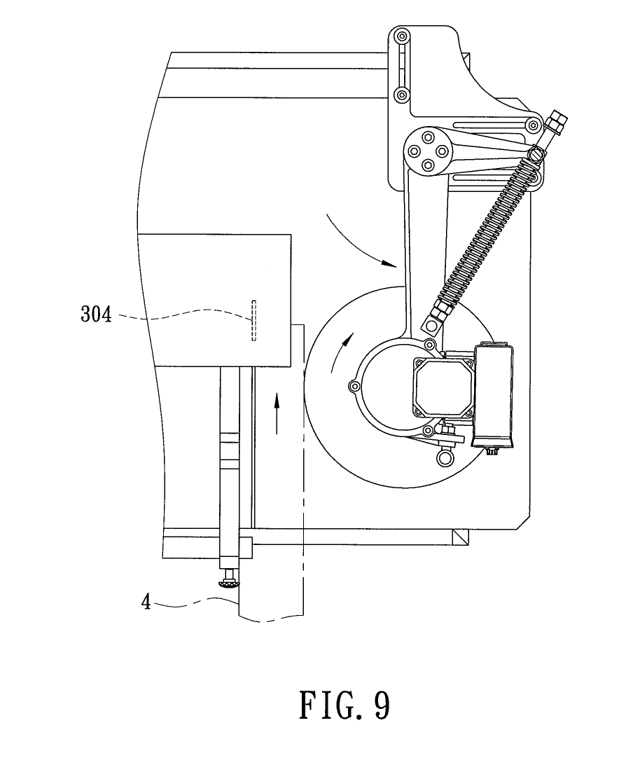

A workpiece 4 to be cut is first placed on the worktable 302 to lean against the fence member 303 (see FIG. 7), and is pushed toward the cutter 304. Once the workpiece 4 comes into contact with the feeding wheel 41, it pushes the feeding wheel 41 away from the fence member 303 in such a manner that contact between the workpiece 4 and the feeding wheel 41 is maintained. Hence, the workpiece 4 is clamped between the feeding wheel 41 and the fence member 303, and the workpiece 4 is driven by the feeding wheel 41 due to frictional contact between the workpiece 4 and the friction layer 411 of the feeding wheel 41 to move toward the cutter 304 during rotation of the feeding wheel 41. Therefore, referring to FIG. 9, the workpiece 4 is cut by the cutter 304.

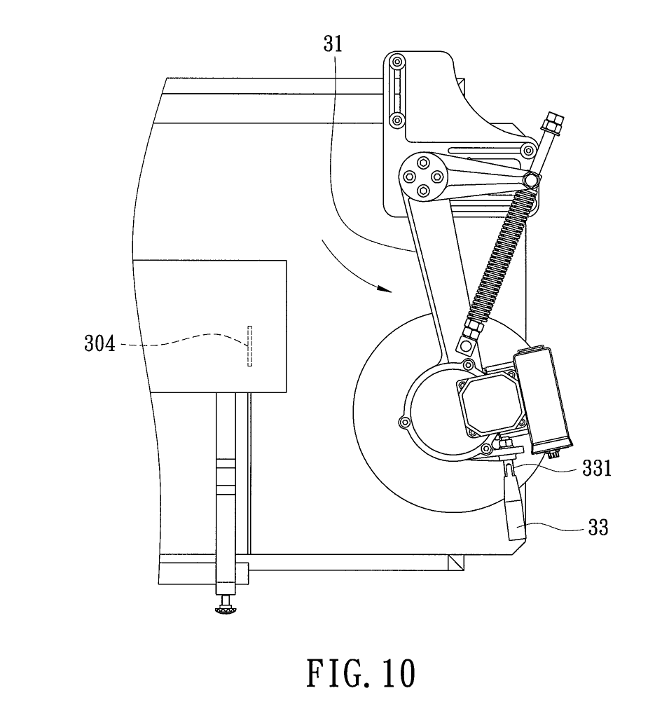

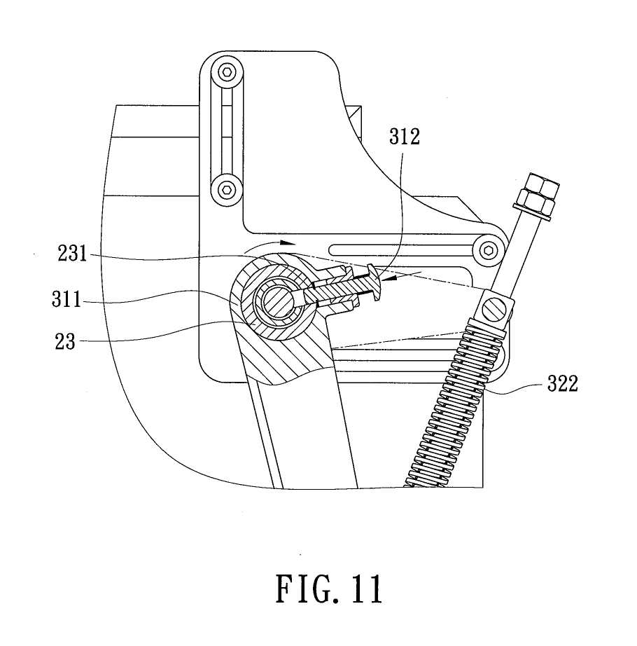

Referring to FIGS. 10 and 11, when it is desired to replace the cutter 304, the rotary lever 33 is operated to pivot the cantilever 31 away from the cutter 304 to an open position shown in FIG. 10 whereat the locking pin 312 is aligned with the positioning hole 231, and the locking pin 312 is pushed into the positioning hole 231 in the pivot shaft 23. At this time, since the wheel-biasing spring 322 provides a biasing force to the cantilever 31 to pivot toward the cutter 304, as described above, the sleeve ring 311 connected fixedly to the pivot end of the cantilever 31 tends to rotate on the pivot shaft 23, such that a torque is applied by the sleeve ring 311 to press the locking pin 312 against a wall of the pivot shaft defining the positioning hole 231 to prevent rotation of the cantilever 31 about the pivot shaft 23. Therefore, when the cantilever 31 is located at the open position, the cutter 304 can be replaced.

To sum up, the advantages of the rotary type feeding device for a woodworking machine according to the present invention are as follows. In the present invention, since the diameter of the feeding wheel 41 is not smaller than 250 mm, the feeding wheel 41 can be pushed easily away from the fence member 303 so as to allow an automatic feeding operation, and the return member 32 replaces the pneumatic cylinder 122 of the conventional feeding device 10 to bias the feeding wheel 41 to move toward the cutter 304. Further, since the motor 51 is disposed above the cantilever 31 and directly above the feeding wheel unit 40, as described above, the woodworking machine mounting the rotary type feeding device of the present invention occupies less room than the woodworking machine 1. It should be noted that the return member 32 can be replaced by a torsion spring in other preferred embodiments. It should be also noted that, some conventional woodworking machines have fence members provided with power-driven feeding rollers or power-driven caterpillar feeders. If this invention is adapted for use with such a woodworking machine, the driving unit 50 can be omitted such that the feeding wheel 41 serves as an idle wheel during a workpiece feeding operation.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A rotary type feeding device for a woodworking machine, the woodworking machine including a body, a worktable disposed on the body, and a cutter extending through the worktable, said rotary type feeding device comprising:
a support post unit including a base adapted to be mounted on the worktable, and a pivot shaft disposed uprightly on said base;
a cantilever unit including a cantilever rotatable about said pivot shaft and having a pivot end proximate to said pivot shaft, and a free end distal from said pivot shaft, and a return member; and
a feeding wheel unit including a feeding wheel disposed pivotally on said free end of said cantilever, said feeding wheel having a diameter that is not smaller than 250 mm;
wherein said return member of said cantilever unit is adapted for biasing said feeding wheel of said feeding wheel unit to pivot toward the cutter.

2. The rotary type feeding device as claimed in claim 1, wherein said support post unit further includes a plurality of clamping members, said base being formed with a plurality of slots permitting said clamping members to extend respectively therethrough, each of said clamping members including a threaded rod and a hook engaging threadably said threaded rod such that the worktable is clamped between said base and said hook.

3. The rotary type feeding device as claimed in claim 1, wherein said pivot shaft is fixed on said base, and said support post unit further includes an extension rod connected fixedly to and extending radially and outwardly from an upper end of said pivot shaft, and a rotating block disposed rotatably on an end of said extension rod distal from said pivot shaft, said return member including a connecting rod having one end connected pivotally to said cantilever, and the other end extending movably through said rotating block, and a wheel-biasing spring sleeved on said connecting rod between said rotating block and said cantilever and adapted for providing a biasing force to pivot said feeding wheel toward the cutter.

4. The rotary type feeding device as claimed in claim 3, wherein said pivot shaft has an annular outer surface formed with a positioning hole, said cantilever unit further including a sleeve ring connected fixedly to said pivot end of said cantilever and sleeved rotatably on said pivot shaft, a locking pin disposed movably on said sleeve ring and movable to engage said positioning hole in said pivot shaft so as to prevent rotation of said cantilever about said pivot shaft, and a pin-biasing spring for biasing said locking pin to remove from said positioning hole in said pivot shaft, said wheel-biasing spring further providing a biasing force to maintain engagement of said locking pin within said positioning hole when no external force is applied.

5. The rotary type feeding device as claimed in claim 4, wherein said cantilever unit further includes a rotary lever having an end connected pivotally to said free end of said cantilever.

6. The rotary type feeding device as claimed in claim 1, wherein the diameter of said feeding wheel is not greater than 990 mm.

7. The rotary type feeding device as claimed in claim 6, wherein a ratio of the diameter of said feeding wheel to a distance between said free end of said cantilever and a central axis of said pivot shaft is greater than 0.6, and smaller than 2.0.

8. The rotary type feeding device as claimed in claim 1, further comprising a driving unit including a motor disposed on said cantilever, and a speed-reducing system disposed between said motor and said feeding wheel.

9. The rotary type feeding device as claimed in claim 8, wherein said motor is disposed above said cantilever and directly above said feeding wheel unit, said speed-reducing system including a small gear driven by said motor, and a large gear connected to said feeding wheel, meshing with said small gear, and having a diameter greater than that of said small gear.

10. The rotary type feeding device as claimed in claim 9, wherein said speed-reducing system further includes a reduction box unit connected between said motor and said small gear.
